(19) United States
(12) Patent Application Publication
(10) Pub. No.: US 2025/0019250 A1
(43) Pub. Date: Jan. 16, 2025

(54) SYNTHESIS OF MFI FRAMEWORK TYPE ZEOLITES

(71) Applicant: Chevron U.S.A. Inc., San Ramon, CA (US)

(72) Inventors: Jesús C. PASCUAL, Berkeley, CA (US); Stacey Ian ZONES, San Francisco, CA (US); Cong-Yan CHEN, Kensington, CA (US)

(21) Appl. No.: 18/764,872

(22) Filed: Jul. 5, 2024

Related U.S. Application Data
(60) Provisional application No. 63/512,519, filed on Jul. 7, 2023.
(60) Provisional application No. 63/512,528, filed on Jul. 7, 2023.

(51) Int. Cl. C01B 39/40; C01B 33/26

(52) U.S. Cl. CPC C01B 39/40; C01B 33/2876; C01P 2002/72

(57) ABSTRACT

A method for synthesizing a zeolite having an of MFI framework structure is provided. The method includes (i) preparing a reaction mixture comprising a source of aluminum, a source of silicon, a structure directing agent comprising 2,2-dipropylpentane-1-amine, a source of fluoride ions, and water; (ii) heating the reaction mixture under crystallization conditions including a temperature of from 100° C. to 200° C. for a time sufficient to form crystals of the aluminosilicate zeolite; and (iii) recovering the crystals of the aluminosilicate zeolite from the reaction mixture.

### CROSS-REFERENCE TO RELATED APPLICATIONS

This application claims priority to and the benefit of U.S. Provisional Application No. 63/512,519 having a filing date of Jul. 7, 2023, and U.S. Provisional Application No. 63/512,528 having a filing date of Jul. 7, 2023, the disclosures of all of which are incorporated herein by reference in their entireties.

### FIELD

The present disclosure relates to a method of synthesizing a zeolite of MFI framework type, and zeolites so made.

### BACKGROUND

Zeolites are crystalline, microporous aluminosilicate molecular sieves built from SiO4 and AlO4 corner-sharing tetrahedral units, forming a regular channel/cavity system with all tetrahedral units located at the channel's surface.

Crystalline zeolite ZSM-5, and its conventional preparation using tetrapropylammonium cations as a structure directing agent, are taught by U.S. Pat. No. 3,702,886 and U.S. Patent No. Re. 29,948.

ZSM-5 has a three-dimensional channel system with two-dimensional sinusoidal channels intersected with parallel, one-dimensional straight channels. ZSM-5 has been assigned the framework structure type MFI by the Structure Commission of the International Zeolite Association. Zeolites with the MFI framework structure provide shape-selective properties that are particularly useful as catalysts for the conversion of methanol to olefins, gasoline, and hydrocarbons (MTO, MTG, MTH), and are particularly useful for the selective cracking of linear paraffins that allows its use as an additive to fluid catalytic cracking catalysts (i.e., FAU zeolites) to produce gasoline with higher octane rating.

The performance of zeolite catalysts is closely related to their acidic properties. The isomorphous Al distribution in the zeolite framework results in a negative charge, which must be compensated by extra-framework cationic species. Compensation of negative charge by a proton leads to the formation of zeolitic Brønsted acid sites (Si(OH) Al), which become active sites in acid-catalyzed reactions. Thus, the quantity, strength and distribution of acid sites in the zeolite framework can have significant effects on catalytic activity and stability and also on product selectivity.

In much of the MFI literature, the syntheses use the tetrapropylammonium (TPA) cation as a structure directing agent (SDA) where the charge on the TPA is located at the intersection of the channels which cross. If the counterbalancing negative charge site (supplied by Al in the framework where Al⁺³ is replacing Si⁺⁴ and thus leaving a negative charge) is also at the intersection, then with a proton attached to the site (after calcination and removal of the TPA) then the acid site for catalytic reactions resides at this site. In turn, this provides a site for catalysis where there is a larger volume for transition states than if the charged acidic site were to reside along an isolated channel which would restrict the space and thus alter the catalytic selectivity for the MFI zeolite.

A number of research groups have tried to engineer the location of these acidic sites from the placement of the Al in the framework. These approaches have included using an additional SDA besides TPA cation, or the balancing of sodium cations as well as TPA in the synthesis to bias which Al may be at the channel intersections and which may be along a given channel. Then, as a measure of their attempted success, some groups have tried to infer success from a change in catalytic reaction.

There is also the issue that the complexity of the MFI zeolite. In general, twelve different T-sites in an MFI unit cell are available for substitution of Si by one Al atom. Four of the twelve T-sites are said to be along the channel and not the intersection and efforts have been forwarded to measure these directly by solid-state Magic Angle Spinning Nuclear Magnetic Resonance Spectroscopy (MAS NMR). However, it is complex to deconvolute the spectra under some experimental conditions to precisely show where the Al sites are located.

Provided herein is a novel way to make MFI zeolite which can affect where the active sites for catalysis are located. The approach herein employs an organic amine (2,2-dipropylpentane-1-amine) where the nitrogen, once charged, would be difficult to situate at the channel intersection and must sit in the channels of the zeolite. The organic amine used herein is shown in FIG. 1. It can be seen from FIG. 1 that 2,2-dipropylpentane-1-amine should fill space the same as TPA, but the charge location will be different. The organic amine will be charged by virtue of running the synthesis in HF media where the nitrogen will then be protonated. This system can produce a high-quality MFI zeolite with no alkali cations (e.g., Na⁺) present in the synthesis where they could charge balance an aluminum at the channel intersection.

### SUMMARY

In a first aspect, the present disclosure relates a method of synthesizing an aluminosilicate zeolite of MFI framework type, the method comprising: (i) preparing a reaction mixture comprising a source of aluminum, a source of silicon, a structure directing agent comprising 2,2-dipropylpentane-1-amine, a source of fluoride ions, and water; (ii) heating the reaction mixture under crystallization conditions including a temperature of from 100° C. to 200° C. for a time sufficient to form crystals of the aluminosilicate zeolite; and (iii) recovering the crystals of the aluminosilicate zeolite from the reaction mixture.

In a second aspect, the present disclosure relates to an aluminosilicate zeolite of MFI framework type having 2,2-dipropylpentane-1-amine cation within its pore structure.

In a third aspect, the present disclosure relates to an aluminosilicate zeolite of MFI framework type having, in its as-calcined form, a Constraint Index of from 5 to 9 and an iso-C4/n-C4 ratio of less than 1, as determined by the Constraint Index Test.

In a fourth aspect, the present disclosure relates to a process of converting an organic compound to a conversion product, which comprises contacting the organic compound with the aluminosilicate zeolite according to the second or third fourth aspect or prepared according to the method of the first aspect.

### BRIEF DESCRIPTION OF THE DRAWINGS

FIG. 1 shows the chemical structures of 2,2-dipropylpentane-1-amine and tetrapropylammonium cation.

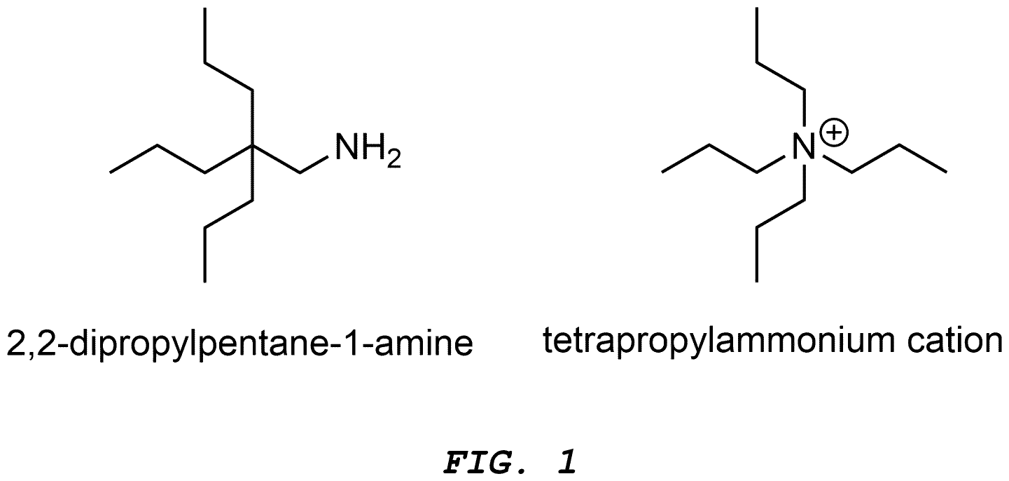

FIG. 2 is the experimental 1H-NMR spectrum of 2,2-dipropylpentanenitrile prepared in Example 1.

FIG. 3 is the experimental 13C-NMR spectrum of 2,2-dipropylpentanenitrile prepared in Example 1.

FIG. 4 is the experimental 13C-DEPT-135 NMR spectrum of 2,2-dipropylpentanenitrile prepared in Example 1.

FIG. 5 is the experimental 1H-NMR spectrum of 2,2-dipropylpentane-1-amine prepared in Example 1.

FIG. 6 is the experimental 13C-NMR spectrum of 2,2-dipropylpentane-1-amine prepared in Example 1.

FIG. 7 is the experimental 13C-DEPT-135 NMR spectrum of 2,2-dipropylpentane-1-amine prepared in Example 1.

FIG. 8 shows a powder X-ray diffraction (XRD) pattern of the as-synthesized product of Example 3.

### DETAILED DESCRIPTION

### Definitions

The “as-synthesized” (or “as-made”) aluminosilicate zeolites of the present disclosure (i.e., before thermal treatment or other treatment to remove the structure directing from the pores) typically include the structure directing agent, one of the components of the reaction mixture, within their pores. The aluminosilicate zeolites of the present disclosure where part or all of the structure directing agent has been removed (e.g., via thermal treatment or other treatment to remove the structure directing agent from the pores), are at least partially calcined or “as-calcined” materials.

The term “framework type” as used herein has the meaning described in the “Atlas of Zeolite Framework Types” by Ch. Baerlocher, L. B. McCusker and D. H. Olson (Elsevier, Sixth Revised Edition, 2007).

The term “MFI” refers to the MFI type topology or framework as recognized by the International Zeolite Association (IZA) Structure Commission and the term “MFI zeolite” means an aluminosilicate molecular sieve in which the primary crystalline phase is MFI.

The term “zeolite” means a synthetic aluminosilicate molecular sieve having a framework constructed of alumina and silica (i.e., repeating AlO₄ and SiO₄ tetrahedral units).

The term “Constraint Index” is a measure of the extent to which a microporous molecular sieve (e.g., zeolites, aluminosilicates) provides controlled access of different sized molecules to its internal structure. For example, molecular sieves which provide a highly restricted access to and egress from its internal structure have a high value for the Constraint Index, and molecular sieves of this kind usually have pores of small size (e.g., less than 5 Å). On the other hand, molecular sieves which provide relatively free access to the internal molecular sieves structure have a low value for the Constraint Index, and usually pores of large size (e.g., greater than 6 Å). The Constraint Index (CI) test is designed to compare reaction rates for the cracking of n-hexane (n-C6) and its isomer 3-methylpentane (3-MP) under competitive conditions. A higher CI value arises from the preferential cracking of n-C6 compared with the branched isomer.

The term “iso-C4/n-C4 ratio” refers to the weight ratio for the paraffin products in the Constraint Index test and is a measure of the available internal space for transition states arising from bimolecular cracking reactions. Generally, a low iso-C4/n-C4 ratio is proportional to a high CI value. In turn, this means a low iso-C4/n-C4 ratio is related to a low conversion of 3-MP. Iso-C4/n-C4 ratios were determined in accordance with S. I. Zones et al. (Micropor. Mesopor. Mater. 2000, 35-36, 31-46) at 800° F.

### The Reaction Mixture

In general, a zeolite of MFI framework type may be synthesized by: preparing a reaction mixture comprising a source of aluminum, a source of silicon, a structure directing agent comprising 2,2-dipropylpentane-1-amine, a source of fluoride ions, and water; (ii) heating the reaction mixture under crystallization conditions including a temperature of from 100° C. to 200° C. for a time sufficient to form crystals of the aluminosilicate zeolite; and (iii) recovering the crystals of the aluminosilicate zeolite from the reaction mixture.

The reaction mixture can have a composition, in terms of molar ratios, within the ranges shown in Table 1.

TABLE 1

| Reactants | Useful | Exemplary |
|---|---|---|
| SiO₂/Al₂O₃ | 25 to 500 | 50 to 150 |
| Q/SiO₂ | 0.2 to 0.8 | 0.2 to 0.5 |
| F/SiO₂ | 0.2 to 0.8 | 0.2 to 0.5 |
| H₂O/SiO₂ | 1 to 50 | 2 to 10 |

The reaction mixture comprises at least one source of aluminum. Generally, all suitable sources for aluminum can be employed, however, an aluminum source is preferably employed which is free of alkali and/or earth alkali metal, in particular free of sodium. By way of example, metallic aluminum such as aluminum powder, suitable aluminates such as alkali metal aluminates, aluminum alkoxides such as aluminum isopropoxide and aluminum hydroxide may be mentioned. According to a preferred embodiment of the present disclosure, however, an aluminum source is employed which is free of alkali and/or earth alkali metal, in particular free of sodium. Aluminum hydroxide, Al(OH)₃, and aluminum isopropoxide are especially preferred.

The reaction mixture comprises at least one source of silicon. Generally, all suitable sources for silicon can be employed, however, a source of silicon is preferably employed which is free of alkali and/or earth alkali metal, in particular free of sodium. By way of example, silicates, silica, silicic acid, colloidal silica, fumed silica, silicon alkoxides, silica hydroxides, precipitated silica or clays may be mentioned.

In certain embodiments, aluminosilicate zeolites can be used as both aluminum and silicon sources for the synthesis. In further embodiments, the reaction mixture may further comprise additional/optional aluminum and/or silicon sources. Particularly preferred aluminosilicate zeolites are synthetic faujasites such as zeolite Y. The aluminosilicate zeolite can be a hydrogen-form zeolite, an ammonium-form zeolite, or an alkali metal form zeolite (e.g., H-form zeolite Y, NH₄-form zeolite Y, Na-form zeolite Y). Preferably, the aluminosilicate zeolite is in the hydrogen-form (e.g., H-form zeolite Y).

The structure directing agent (Q) used to prepare the present aluminosilicate MFI zeolite comprises 2,2-dipropylpentane-1-amine, represented by the following structure (1):

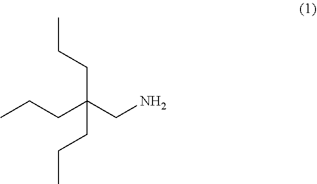

The reaction mixture also contains at least one source of fluoride ions. Especially convenient sources of fluoride ions are hydrogen fluoride (HF), ammonium fluoride (NH₄F), and ammonium bifluoride (NH₄HF₂), in particular HF.

According to one embodiment of the present disclosure, the reaction mixture is free of alkali and/or alkaline-earth metals, in particular free of sodium. The term “free of alkali metal” and “free of sodium”, as used in this context of the present disclosure relates to the fact that no starting materials are employed which contain sodium, in particular alkali metal as essential component, such as, for example, sodium aluminate as source for aluminum, or the like. However, this term does not exclude such embodiments where the starting materials explicitly described contain certain amounts of sodium, in particular alkali metals as impurities. By way of example, such impurities are typically present in amounts of 1000 ppm or less, preferably 100 ppm or less, more preferably 10 ppm or less. The term “an alkali metal content of X ppm or less”, as used in the context of the present disclosure, relates to an embodiment according to which the sum of all alkali metals present does not exceed X ppm. In all cases, alkali metal content is reported on the basis of its metal oxide, for example, 1000 ppm Na₂O. It is recognized that cationic Nat resides within the zeolite pores.

The reaction mixture may further comprise an amount of seed crystals comprising a zeolite preferably having framework type MFI (e.g., ZSM-5). The amount of seed crystals can vary from 0.1 to 25% based on the total amount of silica (SiO₂) in the reaction mixture.

The reaction mixture can be prepared by any conceivable means, wherein mixing by agitation is preferred, preferably by means of stirring. The reaction mixture can be prepared in batch, continuous, or semi-continuous mode.

The reaction mixture can be in the form of a solution, a colloidal dispersion (colloidal sol), gel, or paste, with a gel being preferred.

### Crystallization and Post-Synthesis Treatment

The reaction mixture is then subject to crystallization conditions suitable for the aluminosilicate zeolite to form. Crystallization of the aluminosilicate zeolite may be carried out under static or stirred conditions in a suitable reactor vessel, such as for example Teflon® lined or stainless steel autoclaves placed in a convection oven maintained at an appropriate temperature.

The crystallization in step (ii) of the method is typically carried out at a temperature of 100° C. to 200° C. (e.g., 120° C. to 170° C.) for a time sufficient for crystallization to occur at the temperature used. For instance, at higher temperatures, the crystallization time may be reduced. For instance, the crystallization conditions may include heating for a period of from 1 day to 30 days (e.g., at least 1 day or at least 5 days up to 20 days or 15 days). The crystallization time can be established by methods known in the art such as by sampling the reaction mixture at various times and determining the yield and X-ray crystallinity of precipitated solid. Preferably, the crystallization is carried out under autogenous pressure, preferably in an autoclave.

After the desired crystallization is complete, the solid precipitate containing the zeolite crystals can be separated from the mother liquor which can then be discarded or recycled.

The precipitated zeolite crystals can be recovered by any well-known separation technique, such as, for example, decantation, filtration, ultrafiltration, centrifugation or any other solid-liquid separation technique, and combinations thereof. Preferred methods of separation include mechanical separation such as vacuum filtration. The recovered solids can then be rinsed with deionized or purified water and dried at an elevated temperature for several hours. The drying step can be performed under vacuum or at atmospheric pressure.

In the drying step, the water content is removed from the zeolite after the crystallization step or after the washing step. The conditions of the drying step are discretionary, but an example is drying the zeolite after the crystallization step or after the washing step by leaving the molecular sieve to stand for at least two hours (e.g., 4 to 24 hours) in an environment at a temperature not less than 50° C. and not greater than 150° C.

As a result of the crystallization process, the recovered product contains within its pores at least a portion of the structure directing agent used in the synthesis. The as-synthesized aluminosilicate zeolite recovered from step (iii) may be subjected to thermal treatment or other treatment to remove part or all of the structure directing agent incorporated into its pores during the synthesis. Thermal treatment (e.g., calcination) of the as-synthesized MFI zeolite typically exposes the materials to high temperatures sufficient to remove part or all of the structure directing agent, in an atmosphere selected from air, nitrogen, ozone or a mixture thereof in a furnace. While sub-atmospheric pressure may be employed for the thermal treatment, atmospheric pressure is desired for reasons of convenience. The thermal treatment may be performed at a temperature of from 300° C. to 800° C. (e.g., 400° C. to 650° C.) for a period of time ranging from 1 hour to 10 hours (e.g., 3 hours to 6 hours). The thermal treatment may be carried out in a box furnace in dry air, which has been exposed to a drying tube containing drying agents that remove water from the air. The heating may first be carried out under a nitrogen atmosphere and then the atmosphere may be switched to air and/or ozone.

Removal of the fluoride can be effected by the thermal treatment used to remove the structure directing agent and/or by ion exchange.

This method of synthesis of aluminosilicate MFI zeolite does not require introduction of alkali and/or alkaline-earth metal cations in the reaction medium. As a consequence thereof, the organic cation Q can be the only cation that balances the lattice charges in the aluminosilicate zeolite. Therefore, simple thermal treatment to decompose the organic cation leaves the zeolite in acid form (e.g., H⁺-form MFI zeolite), without first requiring an intermediate ion-exchange against cations and/or cationic elements such as H⁺ and/or NH₄⁺ as is the case for zeolitic materials containing extra-framework alkali and/or alkaline earth metal cations. Therefore, the thermally treated zeolite can be directly subjected to an ion-exchange procedure with one or more metal cations M, wherein the one or more metal cations M are located at the ion-exchange sites of the framework structure of the zeolite.

The one or more metal cations can be selected from transition metals, including titanium (Ti), zirconium (Zr), vanadium (V), niobium (Nb), manganese (Mn), chromium (Cr), molybdenum (Mo), tungsten (W), iron (Fe), cobalt (Co), nickel (Ni), copper (Cu), zinc (Zn), tin (Sn), noble metals including platinum group metals (PGMs), such as ruthenium (Ru), rhodium (Rh), iridium (Ir), palladium (Pd), platinum (Pt), and precious metals such as silver (Ag) and gold (Au); alkaline earth metals such as beryllium (Be), magnesium (Mg), calcium (Ca), strontium (Sr), and barium (Ba); and rare earth metals such as lanthanum (La), cerium (Ce), praseodymium (Pr), neodymium (Nd), europium (Eu), terbium (Tb), erbium (Er), ytterbium (Yb), and yttrium (Y).

The metal can be present in the zeolite at a concentration of 0.1 to 10 wt. % based on the total weight of the zeolite, for example from 0.5 wt. % to 5 wt. %.

Metals incorporated post-synthesis can be added to the zeolite via any known technique such as ion exchange, impregnation, isomorphous substitution, etc.

### The Aluminosilicate MFI Zeolite

The aluminosilicate zeolite of MFI framework type synthesized by the methods described herein can have a SiO₂/Al₂O₃ molar ratio of 50 or more (e.g., 50, 60, 70 or 80 up to 500, or 250, or 100). The SiO₂/Al₂O₃ molar ratio of zeolites can be determined by conventional analysis.

The aluminosilicate zeolite of MFI framework type synthesized by the methods described herein can be free of alkali and/or alkaline-earth metals, in particular free of sodium. The term “free of alkali metal” and “free of sodium”, as used in this context of the present disclosure relates to zeolitic materials having an alkali metal content, and a sodium content, respectively, of 1000 ppm or less, preferably 100 ppm or less, more preferably 10 ppm or less.

The aluminosilicate zeolite of MFI framework type of the present disclosure can have, in its as-calcined form, a Constraint Index of 5 to 9 and/or an iso-C4/n-C4 ratio, as determined in the Constraint Index test, of less than 1.

It will be understood by a person skilled in the art that the aluminosilicate MFI zeolite of the present disclosure may contain impurities, such as amorphous materials; unit cells having non-MFI framework topologies; and/or other impurities (e.g., heavy metals and/or organic hydrocarbons). Typical examples of non-MFI framework type molecular sieves co-existing with the MFI framework type zeolite of the present disclosure include FAU. The MFI framework type zeolites of the present disclosure are preferably substantially free of impurities. The term “substantially free of impurities” used herein means the MFI framework type zeolite of the present disclosure preferably contains a minor proportion (less than 50 wt. %), preferably less than 20 wt. %, more preferably less than 10 wt. %, even more preferably less than 5 wt. % and most preferably less than 1 wt. %, of such impurities (or “non-MFI framework type zeolite”), which weight percent (wt. %) values are based on the combined weight of impurities and pure phase MFI framework type zeolite. The amount of impurities can be appropriately determined by powder XRD, rotating electron diffraction, and/or SEM/TEM (e.g., different crystal morphologies).

The aluminosilicate MFI zeolite described herein are substantially crystalline. As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules and possessing a distinguishable crystal lattice. For example, aluminosilicate MFI zeolite can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content. As used herein, the term “substantially crystalline” means a majority (greater than 50 wt. %) of the weight of a sample of a material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

### Uses of the Aluminosilicate Zeolite of MFI Framework Type

The aluminosilicate molecular sieve of MFI framework type obtainable by the method described herein, where part or all of the structure directing agent has been removed, may be used as an adsorbent or as a catalyst or support for catalyst in a wide variety of hydrocarbon conversions (e.g., conversion of organic compounds to a converted product).

Aluminosilicate MFI zeolite materials (where part or all of the structure directing agent is removed) may be used as an adsorbent, such as for separating at least one component from a mixture of components in the vapor or liquid phase having differential sorption characteristics with respect to the material. Therefore, at least one component can be partially or substantially totally separated from a mixture of components having differential sorption characteristics with respect to the aluminosilicate MFI zeolite material by contacting the mixture with the MFI material to selectively sorb the one component. For instance, in a process for selectively separating one or more desired components of a feedstock from remaining components of the feedstock, the feedstock may be contacted with a sorbent that comprises the aluminosilicate MFI zeolite of the present disclosure at effective sorption conditions, thereby forming a sorbed product and an effluent product. One or more of the desired components are recovered from either the sorbed product or the effluent product.

Aluminosilicate MFI zeolite (where part or all of the structure directing agent is removed) may also be used as a catalyst to catalyze a wide variety of organic compound conversion processes. Examples of chemical conversion processes, which are effectively catalyzed by the aluminosilicate MFI zeolite described herein, either alone or in combination with one or more other catalytically active substances including other crystalline catalysts, include those requiring a catalyst with acid activity. Examples of organic conversion processes, which may be catalyzed by the aluminosilicate MFI zeolite described herein include cracking, hydrocracking, reforming, hydrogenation, dehydrogenation, dewaxing, adsorption, alkylation, oligomerization, conversion methanol to olefins, deNOₓ applications, and combinations thereof. The conversion of hydrocarbon feeds can take place in any convenient mode, for example in fluidized bed, moving bed, or fixed bed reactors depending on the types of process desired.

The aluminosilicate MFI zeolite may be formulated into product compositions by combination with other materials, such as binders and/or matrix materials that provide additional hardness to the finished product. These other materials can be inert or catalytically active materials.

For instance, it may be desirable to incorporate the aluminosilicate MFI zeolite with another material that is resistant to the temperatures and other conditions employed during use. Such materials include synthetic or naturally occurring zeolites as well as inorganic materials such as clays, silica and/or metal oxides such as alumina and mixtures thereof. The metal oxides may be either naturally occurring or in the form of gelatinous precipitates or gels including mixtures of silica and metal oxides. Use of a resistant material in conjunction with the aluminosilicate MFI zeolite, i.e., combined therewith or present during synthesis of the as-made aluminosilicate MFI zeolite, which crystal is active, tends to change the conversion and/or selectivity of the catalyst in certain organic conversion processes. Inactive resistant materials suitably serve as diluents to control the amount of conversion in a given process so that products can be obtained in an economic and orderly manner without employing other means for controlling the rate of reaction. These materials may be incorporated into naturally occurring clays (e.g., bentonite and kaolin) to improve the crush strength of the product under commercial operating conditions. These inactive resistant materials (i.e., clays, oxides, etc.) function as binders for the catalyst. A catalyst having good crush strength can be beneficial because in commercial use, it is desirable to prevent the catalyst from breaking down into powder-like materials.

Naturally occurring clays which may be used include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or after being subjected to calcination, acid treatment or chemical modification. Binders useful for compositing with aluminosilicate MFI zeolite also include inorganic oxides selected from silica, zirconia, titania, magnesia, beryllia, alumina, yttria, gallium oxide, zinc oxide, and mixtures thereof.

In addition to the foregoing materials, the aluminosilicate MFI zeolite may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

These binder materials are resistant to the temperatures and other conditions (e.g., mechanical attrition) which occur in various hydrocarbon separation processes. Thus, the aluminosilicate MFI zeolite may be used in the form of an extrudate with a binder. They are typically bound by forming a pill, sphere, or extrudate. The extrudate is usually formed by extruding the zeolite, optionally in the presence of a binder, and drying and calcining the resulting extrudate. Further treatments such as steaming, and/or ion exchange may be carried out as required. The zeolite may optionally be bound with a binder having a surface area of at least 100 m²/g, for instance at least 200 m²/g, optionally at least 300 m²/g.

The relative proportions of zeolite and inorganic oxide matrix may vary widely, with the zeolite content ranging from 1 to about 100% by weight and more usually, particularly when the composite is prepared in the form of extrudates, in the range of from 2 to 958, optionally from 20 to 90% by weight of the composite.

### EXAMPLES

Aspects of the disclosure are described in greater detail by way of specific examples. The following examples are offered for illustrative purposes and are not intended to limit the disclosure in any manner. Those of skill in the relevant art will readily recognize a variety of parameters can be changed or modified to yield essentially the same results.

NMR experiments were acquired on a Bruker 400 MHz spectrometer, operating at 400 MHz and 100 MHz for 1H and ¹³C nuclei, respectively. Chemical shifts are reported in ppm referenced according to the deuterated solvents used as internal standards: CDCl₃ 7.24 ppm (1H), 77.23 ppm (13C).

### Example 1

### Synthesis of 2,2-Dipropylpentane-1-amine

The preparation procedure of 2,2-dipropylpentane-1-amine is outlined in Scheme 1.

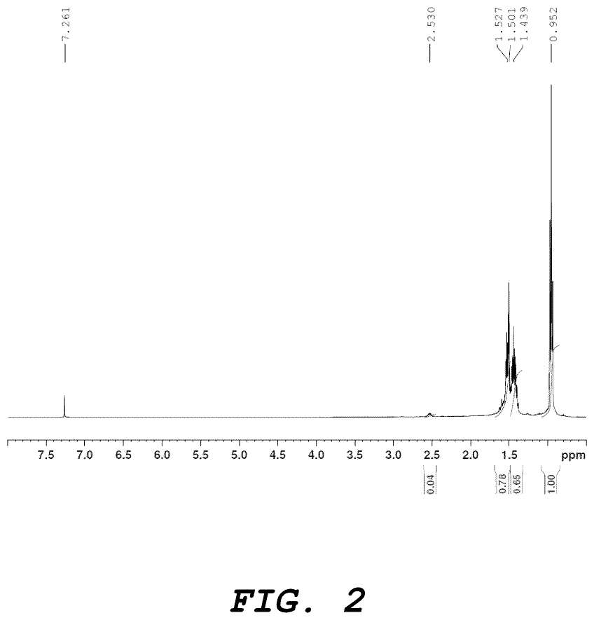

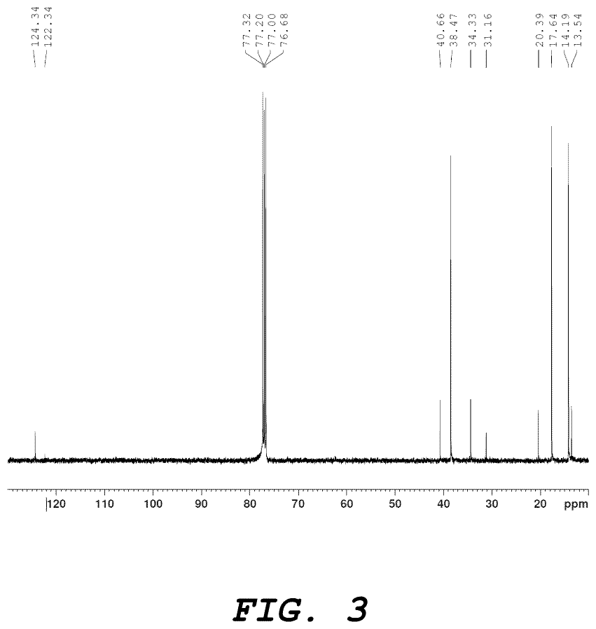

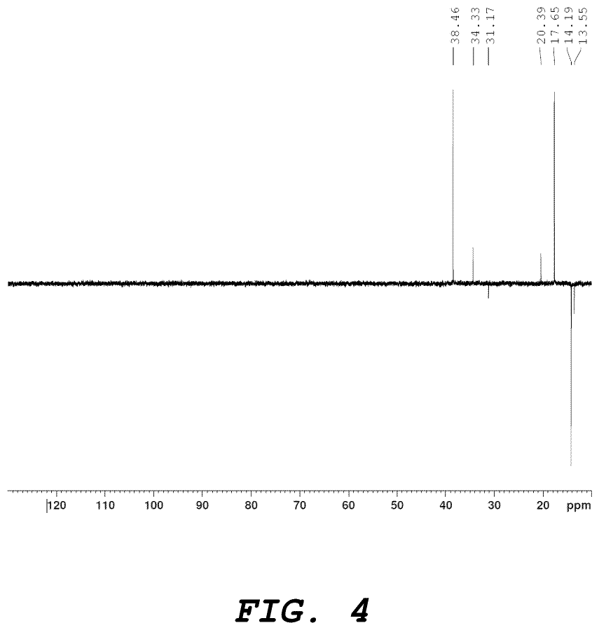

A dry 2-necked round bottom flask equipped with a magnetic stirring bar and rubber septa was purged with nitrogen. The flask was charged with a solution of diisopropylamine (21 mmol) in tetrahydrofuran (THF, 40 mL) and cooled in an acetone-dry ice bath. A solution of n-butyllithium in hexanes (1.6 M, 21 mmol) was added, and the mixture was stirred at −78° C. for 0.5 h. Then, 2-propylpentanenitrile (20 mmol) was added dropwise, and the mixture was stirred at −78° C. for 1 h. Finally, 1-bromopropane (30 mmol) was added dropwise, and the mixture was warmed to room temperature overnight. The reaction flask was removed from the cooling bath, and the reaction was quenched by the careful addition of saturated NH₄Cl (100 mL) followed by addition of ethyl acetate (3×20 mL). The combined organic layers were washed with water, saturated brine, dried (Na₂SO₄), filtered and concentrated to give 2,2-dipropylpentanenitrile as a clear oil (71.4% yield). The product was confirmed by ¹H-, ¹³C- and ¹³C-DEPT-135 NMR spectroscopy. ¹H-NMR, ¹³C-NMR and ¹³C-DEPT-135 NMR spectra of the product are shown in FIGS. 2, 3 and 4, respectively.

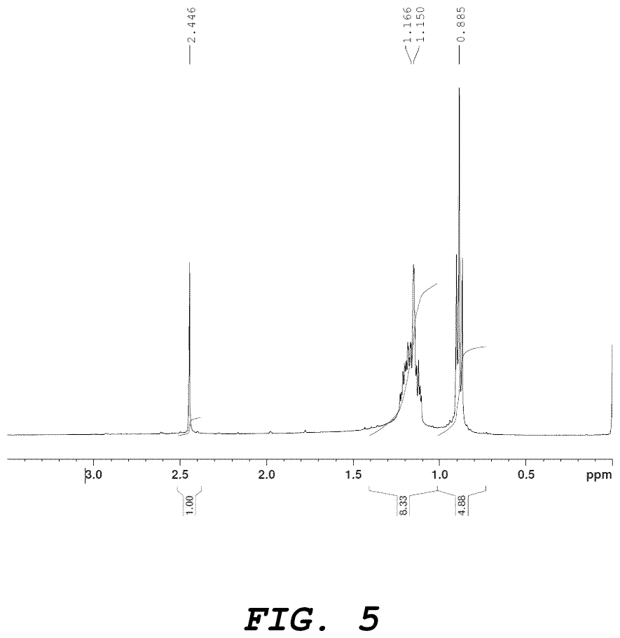

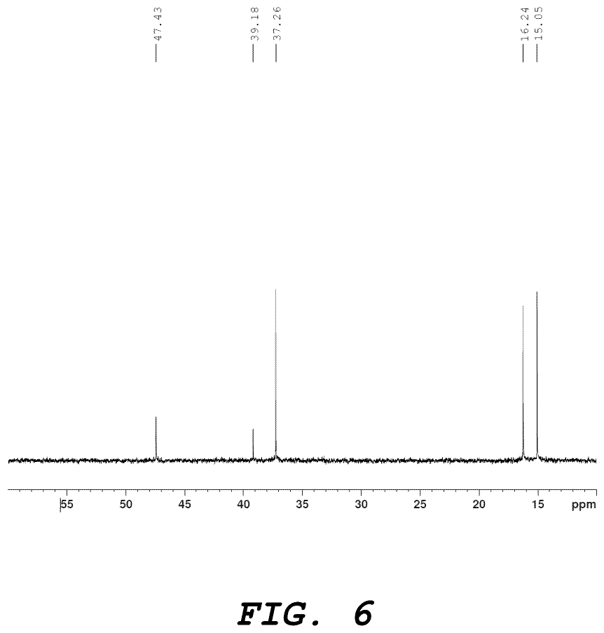

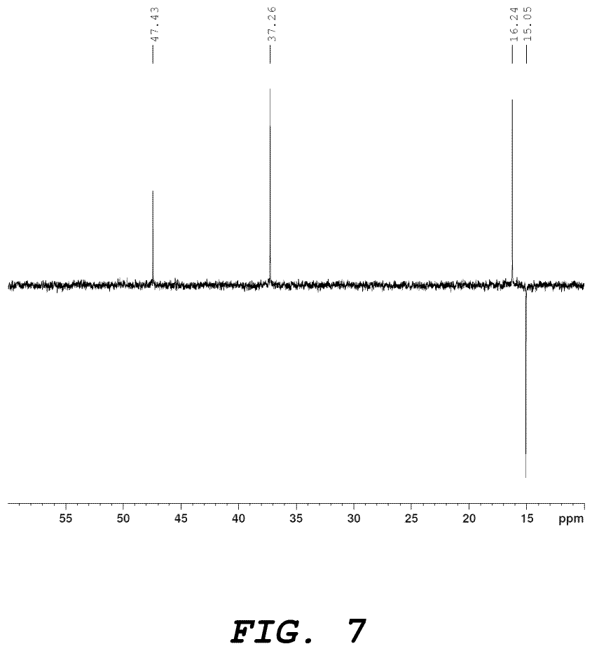

A dry 2-necked round bottom flask equipped with a magnetic stirring bar and rubber septa was purged with nitrogen. The flask was charged with a solution of 2,2-dipropylpentanenitrile (30.6 mmol) in THE (86 mL) and cooled in an acetone-dry ice bath. A solution of lithium aluminum hydride in THF (2.4 M, 46 mmol) was added dropwise, and the mixture was warmed to room temperature overnight. The reaction flask was then moved to an oil bath and the reaction mixture was heated at reflux for 6 h. The reaction flask was removed from the oil bath and allowed to cool to room temperature. The reaction flask was then cooled in an ice bath, and the reaction was quenched by the careful addition of water (2.4 g), 15% NaOH (2.4 g), and additional water (5 g) followed by addition of diethyl ether (50 mL). The solids were filtered and washed with diethyl ether (50 mL). The filtrate was concentrated under reduced pressure to produce a colorless oil. The oil was diluted in 1 M HCl (50 mL) and extracted with diethyl ethyl ether (3×20 mL). The acidic aqueous layer was basified with 15% NaOH and then extracted with diethyl ether (4×20 mL). The combined organic layers were dried (Na₂SO₄), filtered and concentrated to give 2,2-dipropylpentane-1-amine (64% yield). The product was confirmed by ¹H-, ¹³C- and ¹³C-DEPT-135 NMR spectroscopy. 1H-NMR, 13C-NMR and 13C-DEPT-135 NMR spectra of the product are shown in FIGS. 5, 6 and 7, respectively.

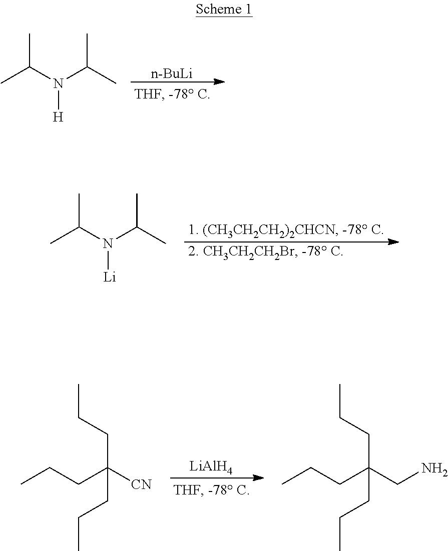

### Example 2

### MFI Synthesis

Tosoh HUA385 FAU zeolite (H-form, SiO₂/Al₂O₃ molar ratio=100, 0.1 wt. % Na₂O) was ion-exchanged 3 times with ammonium nitrate (typically, 1 g NH₄NO₃/1 g zeolite in 10 mL deionized water at 95° C. for at least 2 hours) to remove any possible residual Na cations. The resulting NH₄-form zeolite was converted to the H-form zeolite by calcination, in air, at 540° C. for 5 hours.

A 23 mL Teflon liner was charged with the FAU zeolite (0.75 g), 2,2-dipropyl-1-pentanamine (0.54 g, 3 mmol), deionized water (3 g). Then, 48% HF (0.125 g) was added to neutralize the amine and ensure that all the nitrogen atoms were charged. The liner was then capped and placed within a Parr Steel autoclave reactor. The autoclave was then put in an oven heated at 160° C. with tumbling (43 rpm) for 6 days. The solid product was recovered from the cooled reactor by centrifugation, washed with deionized water and dried at 95° C.

Analysis of the as-synthesized product by powder XRD indicated that the product was phase-pure MFI zeolite.

Scanning electron microscopy (SEM) showed a very uniform field of crystals.

The as-synthesized product was then calcined inside a muffle furnace under a flow of air heated to 540° C. at a rate of 1° C./minute and held at 540° C. for 5 hours, cooled and then analyzed by powder XRD.

### Example 3

### MFI Synthesis

The following components were added (in order) to a 23 mL Teflon liner: 2,2-dipropyl-1-pentanamine (1.5 mmol), deionized water (0.40 g), Tosoh 390HUA Y-zeolite (H-form, 0.3 g, SiO₂/Al₂O₃ molar ratio=500, 0.05 wt. % Na₂O), Reheis F-2000 aluminum hydroxide (0.02 g, 50% Al₂O₃), 50% HF (0.06 g) and as-made MFI seeds (0.02 g). The liner was then capped and placed within a Parr Steel autoclave reactor. The autoclave was then put in an oven heated at 160° C. under static conditions for 6 days and then heated for an additional 15 days. The solid product was recovered from the cooled reactor by centrifugation, washed with deionized water and dried at 95° C.

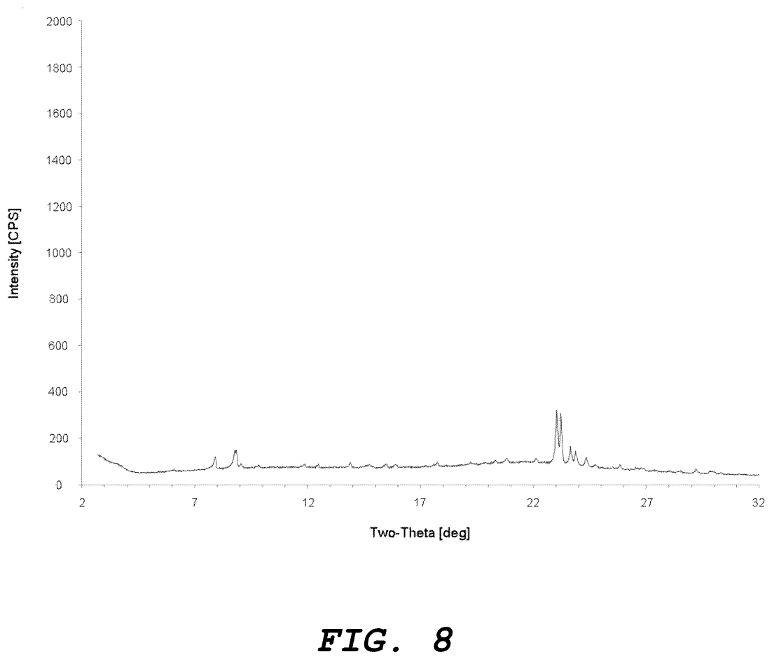

Analysis of the as-made product by powder XRD (FIG. 8) indicated that the product was pure phase MFI zeolite.

### Example 4

### Constraint Index

The as-synthesized product of Example 2 was calcined inside a muffle furnace under a flow of air heated to 540° C. at a rate of 1° C./minute and held at 540° C. for 5 hours before the sample was allowed to cool to room temperature.

For Constraint Index testing, the calcined MFI zeolite was pelletized and crushed to 20-40 mesh size. Constraint Index was measured in accordance with S. I. Zones et al. (Micropor. Mesopor. Mater. 2000, 35-36, 31-46) at 800° F.

A key finding in the test was that the iso-C4/n-C4 product ratio was below 1, an unusual result for an MFI material. A typical iso-C4/n-C4 product ratio for MFI is 1.5 at a CI value of 6. See, for example, T. M. Davis et al. (J. Catal. 2013, 298, 84-93). The results indicate that the MFI zeolite prepared as described herein is more shape-selective than conventional forms of ZSM-5, possibly due to a better locating of Al sites in the channels and away from the channel intersections.

1. A method of synthesizing an aluminosilicate zeolite of MFI framework type, the method comprising:
(i) preparing a reaction mixture comprising a source of aluminum, a source of silicon, a structure directing agent (Q) comprising 2,2-dipropylpentane-1-amine, a source of fluoride ions (F), and water;
(ii) heating the reaction mixture under crystallization conditions including a temperature of from 100° C. to 200° C. for a time sufficient to form crystals of the aluminosilicate zeolite; and
(iii) recovering the crystals of the aluminosilicate zeolite from the reaction mixture.

2. The method of claim 1, wherein the reaction mixture has a composition, in terms of molar ratios, as follows:

| | |
|---|---|
| SiO₂/Al₂O₃ | 25 to 500 |
| Q/SiO₂ | 0.2 to 0.8 |
| F/SiO₂ | 0.2 to 0.8 |
| H₂O/SiO₂ | 1 to 50. |

3. The method of claim 1, wherein the reaction mixture has a composition, in terms of molar ratios, as follows:

| | |
|---|---|
| SiO₂/Al₂O₃ | 50 to 150 |
| Q/SiO₂ | 0.2 to 0.5 |
| F/SiO₂ | 0.2 to 0.5 |
| H₂O/SiO₂ | 2 to 10. |

4. The method of claim 1, wherein the reaction mixture is free of alkali and/or alkaline-earth metals.

5. The method of claim 1, wherein the heating in (ii) is conducted under autogenous pressure.

6. The method of claim 1, wherein the source of aluminum and the source of silicon both comprise synthetic faujasite.

7. The method of claim 1, further comprising (iv) treating the aluminosilicate zeolite recovered in (iii) to remove at least part of the structure directing agent (Q).

8. The method of claim 7, further comprising (v) subjecting the aluminosilicate obtained in (iv) to an ion-exchange procedure with one or more metal cations M.

9. An aluminosilicate zeolite of MFI framework type having, in its as-synthesized form, 2,2-dipropylpentane-1-amine cation within its pore structure.

10. The aluminosilicate zeolite of claim 9, wherein the zeolite has a SiO₂/Al₂O₃ molar ratio of from 50 to 500 or from 50 to 100.

11. The aluminosilicate zeolite of claim 9, wherein the zeolite is free of alkali and/or alkaline-earth metals.

12. An aluminosilicate zeolite of MFI framework type having, in its as-calcined form, a Constraint Index of from 5 to 9 and an iso-C4/n-C4 ratio of less than 1, as determined by the Constraint Index Test.

13. The aluminosilicate zeolite of claim 12, wherein the zeolite has a SiO₂/Al₂O₃ molar ratio of from 50 to 500 or from 50 to 100.

14. A process of converting an organic compound to a conversion product, the process comprising contacting the organic compound with a zeolite of MFI framework type having, in its as-calcined form, a Constraint Index of from 5 to 9 and an iso-C4/n-C4 ratio of less than 1, as determined by the Constraint Index Test.
